(19) United States
(12) Patent Application Publication
(10) Pub. No.: US 2014/0376433 A1
(43) Pub. Date: Dec. 25, 2014

(54) Wireless channel access method and system

(71) Applicant: ZTE Corporation, Shenzhen, Guangdong (CN)

(72) Inventors: Nan Li, Shenzhen (CN); Kaiying Lv, Shenzhen (CN); Jing Jiang, Shenzhen (CN); Kaibo Tian, Shenzhen (CN); Bo Sun, Shenzhen (CN)

(73) Assignee: ZTE Corporation, Shenzhen, Guangdong (CN)

(21) Appl. No.: 14/360,405

(22) PCT Filed: Nov. 6, 2012
(86) PCT No.: PCT/CN2012/084165

§ 371 Date: Jul. 23, 2014

(30) Foreign Application Priority Data
Nov. 7, 2011 (CN) 201110350018.0

(51) Int. Cl. H04W 74/08; H04W 52/02

(52) U.S. Cl. CPC H04W 74/0816; H04W 52/0225
USPC 370/311; 370/329

(57) ABSTRACT

Disclosed are a method and system for accessing a wireless channel. An access point transmits a radio frame including access parameters of at least one group of stations (STAs); and when receiving the radio frame, an STA belonging to the at least one group of STAs transmits data to be transmitted competitively within an uplink transmission period in the access parameters according to the access parameters of the group of STAs. With the disclosure, system overhead can be reduced while low power consumption of a station is ensured.

### TECHNICAL FIELD

The disclosure relates to the field of wireless communication, and in particular to a method and system for accessing a wireless channel.

### BACKGROUND

At present in the field of wireless networks, Wireless Local Area Networks (WLAN) develop rapidly, with a growing demand for global WLAN coverage. The IEEE 802.11 working group defined a series of WLAN technical standards such as 802.11a, 802.11b and 802.11g. Other task forces committed to developing specifications improving existing 802.11 techniques then appear successively. For example, the 802.11ah task force mainly aims at using resources in license-free frequency bands of 1 GHz and below to support a new network application such as load distribution in a smart grid, a sensor network or a cellular network.

In 802.11, a station (STA) may be an Access Point (AP) or a non-AP Station (non-AP STA). One AP and multiple non-AP STAs associated with the AP constitute one Basic Service Set (BSS). 802.11 defines two basic accessing mechanisms, i.e., Distributed Coordination Function (DCF) and Point Coordination Function (PCF), as well as improved modes based on the two basic mechanisms, i.e., Enhanced Distributed Channel Access (EDCA) and Hybrid Coordination Function Controlled Channel Access (HCCA). The DCF is the most basic mechanism, which enables sharing of a wireless channel by multiple STAs via random backoff and Carrier Sense Multiple Access with Collision Avoidance (CSMA/CA). The EDCA and the HCCA support channel access by a QoS station. By random backoff and CSMA/CA, the EDCA allows queues with different priorities to share one wireless channel and reserve a Transmission Opportunity (TXOP). With the HCCA, during a Controlled Access Phase (CAP), an AP acquires control by virtue of a waiting time shorter than that of a non-AP STA, and polls with a polling radio frame CF-Poll; a polled non-AP STA is granted a TXOP.

An existing WLAN system supports a station to operate in a power-saving mode namely by operating alternatively in an awake state and a doze state. For example, by a Power Save Multi-Poll (PSMP) mechanism, a PSPM frame is broadcasted by an AP, defining, for each non-AP STA, a downlink transmission (from the AP to the non-AP STA) period and an uplink transmission (from the non-AP STA to the AP) period; the non-AP STA receives data during the downlink transmission period defined for the non-AP and transmits data during the uplink transmission period defined for the non-AP. When data are not received or transmitted, the non-AP STA may enter a doze state. To facilitate description, a non-AP STA is referred to as an STA for short hereinafter.

At present, most sensors operate in a battery-powered or unattended mode, which requires a 802.11ah STA to support a power-saving performance in an embodiment with a service time lasting months or even years. Traditionally power saving is achieved by the PSMP mechanism, i.e., by transmission of a PSMS frame scheduling a downlink transmission period an uplink transmission period for each STA such that the STA operates alternatively in an awake state and a doze state. However, a scenario where the 802.11ah applies, such as a smart grid, an environment monitoring station, or a smart home system, is characterized by massive STAs; for a 802.11ah system with a number of STAs that is tens of times of that of STAs under a traditional AP, signaling overhead with this method will be huge. Furthermore, one AP may be associated with more than 6,000 STAs, and simultaneous access of a channel by so many STAs will lead to a lot of collisions, leading to increased delay in access.

### SUMMARY

In view of this, it is desired that embodiments of the disclosure provide a method and system for accessing a wireless channel, capable of reducing system overhead while ensuring low power consumption of a station.

To this end, a technical solution of the disclosure is implemented as follows.

A method for accessing a wireless channel includes steps of:
transmitting, by an access point, a radio frame including access parameters of at least one group of stations (STAs); and
receiving, by a station, the radio frame, and, when the station belongs to the at least one group of STAs stations and has data to be transmitted, transmitting the data to be transmitted competitively within an uplink transmission period in the access parameters according to the access parameters of the group of STAs.

In an embodiment, the method may further include:

making an STA belonging to the at least one group of STAs that receives the radio frame but has no data to be transmitted stay in a doze state outside a downlink transmission period of the STA or of the group of STAs in the access parameters; and
making an STA other than the at least one group of STAs that receives the radio frame stay in a doze state within the downlink transmission period and the uplink transmission period in the access parameters.

In an embodiment, the method may further include: after an STA receives the radio frame,
determining, by the STA, whether the STA itself belongs to the at least one group of STAs according to information on a group identification of an STA and/or an identification of an STA in the access parameters.

In an embodiment, the access parameters of the at least one group of STAs may include: information on a group identification of an STA and/or an identification of an STA; a starting time point of downlink transmission; and a downlink transmission duration; or
the access parameters of the at least one group of STAs may include: information on a group identification of an STA and/or an identification of an STA, a starting time point of uplink transmission; and an uplink transmission duration; or
the access parameters of the at least one group of STAs may include: information on a group identification of an STA and/or an identification of an STA; a starting time point of downlink transmission; a downlink transmission duration; a starting time point of uplink transmission; and an uplink transmission duration; or
the access parameters of the at least one group of STAs may include: information on a group identification of an STA and/or an identification of an STA.

In an embodiment, the step of transmitting the data to be transmitted competitively within an uplink transmission period in the access parameters according to the access parameters of the group of STAs may include:
competing, by the STA belonging to the at least one group of STAs that receives the radio frame and has the data to be transmitted, for a channel using a random backoff mechanism and a Carrier Sense Multiple Access with Collision Avoidance (CSMA/CA) mechanism upon arrival of a starting time point of uplink transmission in the access parameters; and
performing data transmission by an STA winning the channel, wherein a period during which the STA winning the channel occupies the channel is no more than an uplink transmission duration in the access parameters.

In an embodiment, the method may further include:
after completing the data transmission, entering, by the STA winning the channel, a doze state; and
continuing, by an STA belonging to the at least one group of STAs that has data to be transmitted, to compete for the channel and performing data transmission until expiration of the uplink transmission period of the group of STAs.

A system for accessing a wireless channel includes an access point and a plurality of stations (STAs), wherein
the access point is configured for transmitting a radio frame including access parameters of at least one group of STAs; and
an STA of the plurality of STAs is configured for: when receiving the radio frame and determining that the STA itself belongs to the at least one group of STAs and has data to be transmitted, transmitting the data to be transmitted competitively within an uplink transmission period in the access parameters according to the access parameters of the group of STAs.

In an embodiment, the STA may be further configured for: when receiving the radio frame, staying in a doze state outside a downlink transmission period of the STA or of the group of STAs in the access parameters when the STA belongs to the at least one group of STAs and has no data to be transmitted; or when receiving the radio frame, staying in a doze state within the downlink transmission period and the uplink transmission period in the access parameters when the STA is not included in the at least one group of STAs.

In an embodiment, the STA may be further configured for determining whether the STA itself belongs to the at least one group of STAs according to information on a group identification of an STA and/or an identification of an STA in the access parameters.

In an embodiment, the access parameters of the at least one group of STAs may include: information on a group identification of an STA and/or an identification of an STA; a starting time point of downlink transmission; and a downlink transmission duration; or
the access parameters of the at least one group of STAs may include: information on a group identification of an STA and/or an identification of an STA, a starting time point of uplink transmission; and an uplink transmission duration; or
the access parameters of the at least one group of STAs may include: information on a group identification of an STA and/or an identification of an STA; a starting time point of downlink transmission; a downlink transmission duration; a starting time point of uplink transmission; and an uplink transmission duration; or
the access parameters of the at least one group of STAs may include: information on a group identification of an STA and/or an identification of an STA.

In an embodiment, the STA may specifically be configured for: competing, when the STA has data to be transmitted, for a channel using a random backoff mechanism and a Carrier Sense Multiple Access with Collision Avoidance (CSMA/CA) mechanism upon arrival of a starting time point of uplink transmission in the access parameters; performing data transmission when winning the channel, wherein a period during which the STA winning the channel occupies the channel is no more than an uplink transmission duration in the access parameters; and after completing the data transmission, entering a doze state.

In an embodiment, the STA may be further configured for: when the STA has data to be transmitted and has not won the channel, after an STA winning the channel completes data transmission, continuing to compete for the channel and performing data transmission until expiration of the uplink transmission period of the group of STAs.

In the disclosure, an access point transmits a radio frame including access parameters of at least one group of STAs, such that an STA accesses a channel and performs data transmission competitively within an uplink transmission period scheduled for the STA, reducing system overhead in transmitting uplink transmission period parameters for STAs while ensuring low power consumption of a station, thereby saving power and achieving a longer battery service time.

### BRIEF DESCRIPTION OF THE DRAWINGS

FIG. 1 is a flow chart of implementing a method for accessing a wireless channel according to the disclosure;

FIG. 2 is a schematic diagram of parameters included in a radio frame of a method for accessing a wireless channel according to embodiment 1 of the disclosure;

FIG. 3 is a schematic diagram of a frame sequence of a method for accessing a wireless channel according to embodiment 1 of the disclosure;

FIG. 4 is a schematic diagram of parameters included in a radio frame of a method for accessing a wireless channel according to embodiment 2 of the disclosure;

FIG. 5 is a schematic diagram of a frame sequence of a method for accessing a wireless channel according to embodiment 2 of the disclosure;

FIG. 6 is a schematic diagram of parameters included in a radio frame of a method for accessing a wireless channel according to embodiment 3 of the disclosure;

FIG. 7 is a schematic diagram of a frame sequence of a method for accessing a wireless channel according to embodiment 3 of the disclosure;

FIG. 8 is a schematic diagram of parameters included in a radio frame of a method for accessing a wireless channel according to embodiment 4 of the disclosure;

FIG. 9 is a schematic diagram of a frame sequence of a method for accessing a wireless channel according to embodiment 4 of the disclosure;

FIG. 10 is a schematic diagram of a frame sequence of a method for accessing a wireless channel according to embodiment 5 of the disclosure; and

FIG. 11 is a schematic diagram of a structure of a system for accessing a wireless channel according to the disclosure.

### DETAILED DESCRIPTION

In embodiments of the disclosure, an access point transmits a radio frame including access parameters of at least one group of stations (STAs); and when receiving the radio frame, an STA belonging to the at least one group of STAs transmits data to be transmitted competitively within an uplink transmission period in the access parameters according to the access parameters of the group of STAs.

To clearly show a technical problem to be solved, a technical solution, and beneficial effects of the present disclosure, the present disclosure is further elaborated below with reference to the drawings and embodiments.

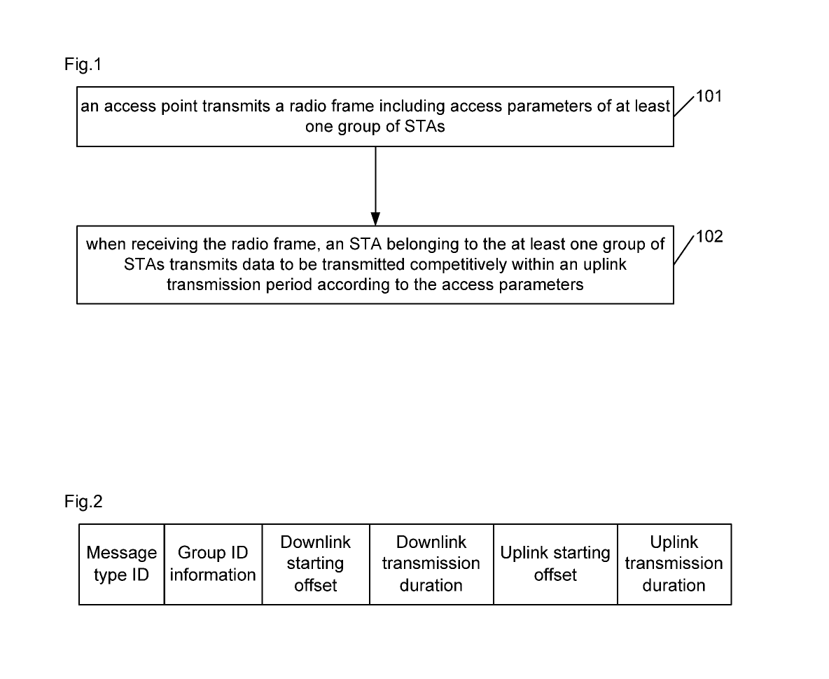

FIG. 1 shows a flow chart of implementing a method for accessing a wireless channel according to the disclosure. As shown in FIG. 1, the method includes steps as follows.

In step 101, an access point transmits a radio frame including access parameters of at least one group of STAs.

Here an access point transmits a radio frame, which includes access parameters of one or more groups of STAs, wherein the one or more groups of STAs are grouped according to a service application, an operator, a network accessing order, or an identification (ID) number of an STA; in an embodiment, the access point may transmit the radio frame by broadcast.

Content included in access parameters of a group of STAs may vary as follows.

Access parameters of a group of STAs may include: information on a group identification of an STA and/or an identification of the STA; a starting time point of downlink transmission; and a downlink transmission duration.

Alternatively, access parameters of a group of STAs may include: information on the group identification of an STA and/or the identification of the STA, a starting time point of uplink transmission; and an uplink transmission duration.

Alternatively, access parameters of a group of STAs may include: information on the group identification of an STA and/or the identification of the STA; a starting time point of downlink transmission; a downlink transmission duration; a starting time point of uplink transmission; and an uplink transmission duration.

The starting time point of downlink transmission and the downlink transmission duration may be collectively referred to as the downlink transmission period; and the starting time point of uplink transmission and the uplink transmission duration may be collectively referred to as the uplink transmission period.

In step 102, when receiving the radio frame, an STA belonging to the at least one group of STAs transmits data to be transmitted competitively within an uplink transmission period in the access parameters according to the access parameters of the group of STAs.

In this step, after the STA receives the radio frame, the STA determines whether the STA itself belongs to the at least one group of STAs according to information on a group identification of an STA and/or an identification of an STA included in the access parameters carried in the radio frame; specifically, when information on the group identification of the STA and/or the identification of the STA itself is identical with the information on the group identification of and/or the identification of an STA included in the access parameters, it is determined that the STA belongs to the at least one group of STAs, or when information on the group identification of the STA and/or the identification of the STA itself is not included in the access parameters, it is determined that the STA does not belong to the at least one group of STAs.

An STA belonging to the at least one group of STAs that receives the radio frame but has no data to be transmitted may stay in a doze state outside a downlink transmission period of the STA or of the group of STAs in the access parameters.

An STA other than the at least one group of STAs that receives the radio frame may stay in a doze state within the downlink transmission period and the uplink transmission period in the access parameters.

Specifically, an STA belonging to the at least one group of STAs that has data to be transmitted may compete for a channel using a random backoff mechanism and a CSMA/CA mechanism upon arrival of a starting time point of uplink transmission in the access parameters; and perform data transmission when winning the channel, wherein a period during which the STA winning the channel occupies the channel may be no more than an uplink transmission duration in the access parameters.

After completing the data transmission, the STA winning the channel may enter a doze state; and when the uplink transmission period of the group of STAs has not expired, an STA belonging to the group of STAs other than the STA winning the channel may continue to compete for the channel to transmit data to be transmitted until expiration of the uplink transmission period of the group of STAs.

The method for accessing a wireless channel provided by the disclosure will be elaborated below through specific embodiments, in which the access point may be denoted by AP, and an STA refers in particular to a non-AP STA.

### Embodiment 1

In Embodiment 1, a radio frame transmitted by an AP includes access parameters of one group of STAs.

In step 11, an AP transmits a radio frame by broadcast to allocate a downlink transmission period and an uplink transmission period for a group of STAs.

Here, access parameters carried by the radio frame includes at least one of: information on a group identification of an STA and/or an identification of an STA, a starting time point of downlink transmission, a downlink transmission duration, a starting time point of uplink transmission and an uplink transmission duration.

Specifically, see FIG. 2 for the parameters included in the radio frame. The radio frame specifically includes: a message type identification, group identification information, a downlink starting offset, a downlink transmission duration, an uplink starting offset and an uplink transmission duration. The message type identification serves to enable a receiving end to identify a frame format of a received radio frame; the downlink starting offset is a starting time point of downlink transmission and may be a starting value in general units of time or in units of intervals between two beacon frames in a system; the downlink duration may be a duration that may also be in general units of time or in units of intervals between two beacon frames in a system. If the AP doesn't allocate an uplink or downlink transmission period for the group of STAs, the unallocated parameter is set to 0.

Here the group of STAs may be STAs grouped according to a service application, an operator, a network accessing order, or an ID number of an STA. A group identification is pre-allocated for each group, and will be included in the radio frame.

In the embodiment, a group of STAs may be indicated by carrying a number of STAs and a list of STA IDs or an STA bitmap in the radio frame; each bit in the bitmap corresponds to an STA under the AP; 1 or 0 may be used to indicate whether a downlink transmission period or an uplink transmission period is allocated for an STA.

In step 12, after receiving the radio frame, an STA determines whether a downlink transmission period and an uplink transmission period are allocated in the radio frame for a group to which the STA belongs, and if so, the STA receives data in the downlink transmission period; when having data to be transmitted, the STA doesn't enter a doze state after downlink reception completes, and competes for a channel upon start of uplink transmission; or when having no data to be transmitted, the STA enters a doze state.

When winning a transmission opportunity (TXOP), an STA may perform transmission up to the end of the uplink transmission duration. If failing to win a TXOP, the STA enters a doze state until the uplink transmission period expires; after waiting for a fixed inter-frame interval, the STA receives a next radio frame broadcast as aforementioned; here indication of whether there will be a next broadcast radio frame may also be included in the current radio frame.

The step may also include that: after receiving the radio frame, if an STA determines that a downlink transmission period and an uplink transmission period are not allocated in the radio frame for a group to which the STA belongs, the STA may enter a doze state until the currently allocated uplink transmission period expires; after waiting for a fixed inter-frame interval, the STA receives a next radio frame broadcast as aforementioned.

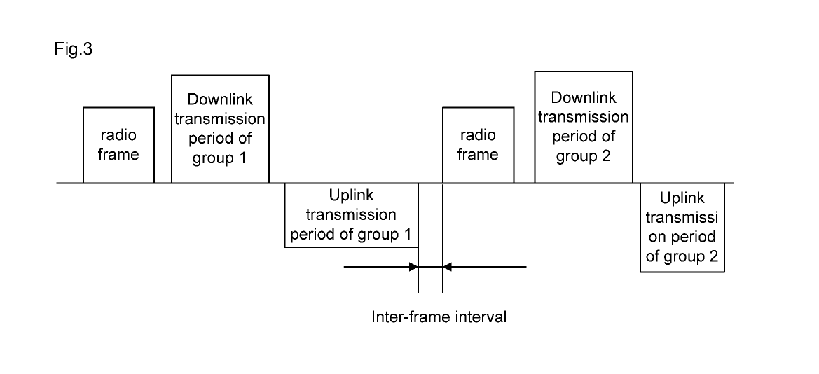

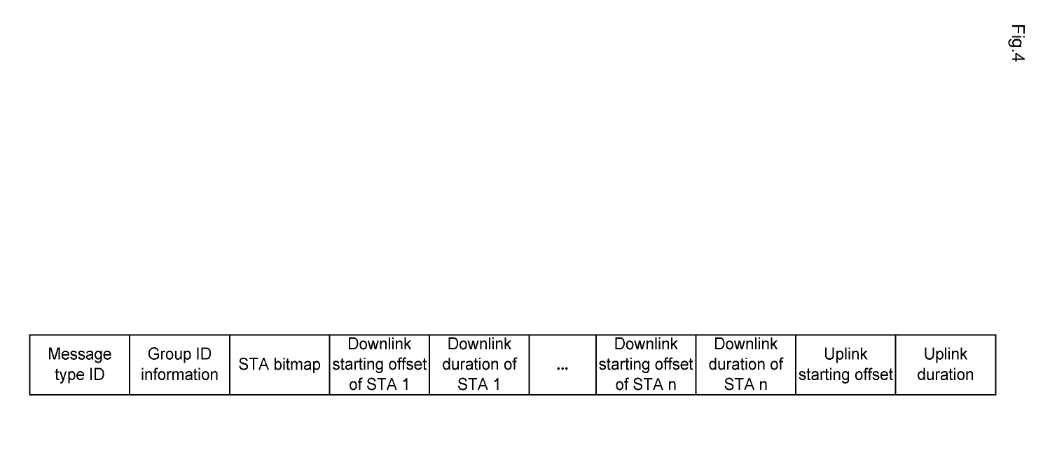

Specifically, a schematic diagram of a frame sequence of the operation process may be as shown in FIG. 3, where it can be seen that the group of STAs share one downlink transmission period and one uplink transmission period; when STAs in the group need to transmit data, they compete for a channel within the shared uplink transmission period to acquire a TXOP.

### Embodiment 2

In Embodiment 2, a radio frame transmitted by an AP includes access parameters of one group of STAs. Embodiment 2 differs from Embodiment 1 in that a downlink transmission period is allocated in the radio frame in Embodiment 2 respectively for each of one or more STAs in the group of STAs.

In step 21, an AP transmits a radio frame by broadcast to allocate a downlink transmission period and an uplink transmission period for a group of STAs.

A downlink transmission period is allocated respectively for each of one or more STAs in the group of STAs. Access parameters carried by the radio frame includes at least one of: information on a group identification of an STA and/or an identification of an STA, a starting time point of downlink transmission, a downlink transmission duration, a starting time point of uplink transmission and an uplink transmission duration.

Specifically, see FIG. 4 for the parameters included in the radio frame. The radio frame specifically includes: a message type identification, group identification information, an STA bitmap, a downlink starting offset of STA 1, a downlink duration of STA 1, . . . , a downlink starting offset of STA n, a downlink duration of STA n, an uplink starting offset and an uplink duration. The message type identification serves to enable a receiving end to identify a frame format of a received radio frame; the downlink starting offset of STA 1 is a starting time point of downlink transmission of STA 1 and may be a starting value in general units of time or in units of intervals between two beacon frames in a system; the downlink duration may be a duration that may also be in general units of time or in units of intervals between two beacon frames in a system. If the AP doesn't allocate an uplink or downlink transmission period for an STA in the group of STAs, the unallocated parameter is set to 0.

Here the group of STAs may be STAs grouped according to a service application, an operator, a network accessing order, or an ID number of an STA. A group identification is pre-allocated for each group and will be included in the radio frame.

In embodiment 2, as a downlink transmission period is allocated respectively for each of one or more STAs in the group of STAs, the radio frame should further include the number of STAs and a list of STA IDs or an STA bitmap. The radio frame in FIG. 4 is illustrated as including an STA bitmap; each bit in the bitmap corresponds to one STA; 1 or 0 may be used to indicate whether a downlink transmission period or an uplink transmission period is allocated for an STA. An STA allocated with a downlink transmission period reads the starting time point of downlink transmission and the downlink transmission duration allocated for the STA.

Step 22, after receiving the radio frame, an STA determines whether a downlink transmission period and an uplink transmission period are allocated in the radio frame for the STA, and if so, the STA receives data in the downlink transmission period allocated for the STA; when having data to be transmitted, the STA doesn't enter a doze state after downlink reception completes, and starts to compete for a channel upon start of uplink transmission; or when having no data to be transmitted, the STA enters a doze state.

When winning a TXOP, an STA may perform transmission up to the end of the uplink transmission duration. If failing to win a TXOP, the STA enters a doze state until the uplink transmission period expires; after waiting for a fixed inter-frame interval, the STA receives a next radio frame broadcast as aforementioned.

The step may also include that: after receiving the radio frame, if an STA determines that a downlink transmission period and an uplink transmission period are not allocated in the radio frame for the STA, the STA may enter a doze state until the currently allocated uplink transmission period expires; after waiting for a fixed inter-frame interval, the STA receives a next radio frame broadcast as aforementioned.

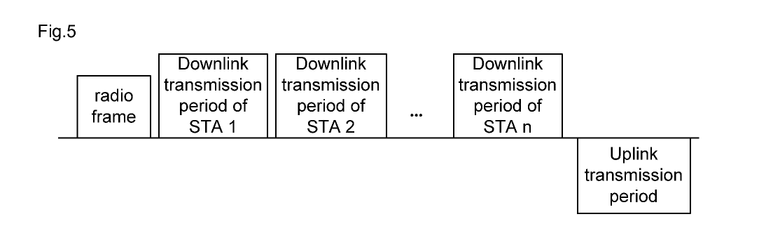

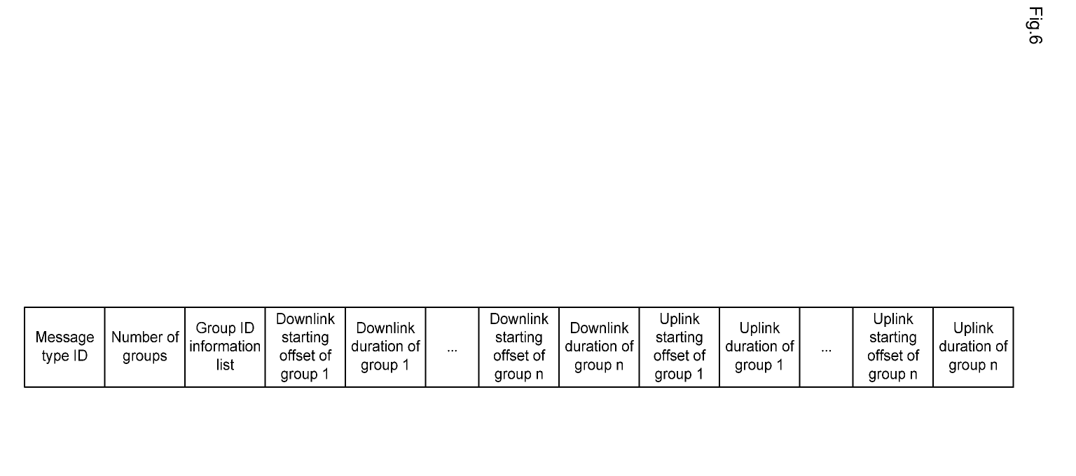

Specifically, a schematic diagram of a frame sequence of the operation process may be as shown in FIG. 5, where it can be seen that a respective downlink transmission period is allocated for each STA in the group, and the group of STAs share one uplink transmission period; when STAs in the group need to transmit data, they compete for a channel within the shared uplink transmission period to acquire a TXOP.

### Embodiment 3

In Embodiment 3, a radio frame transmitted by an AP includes access parameters of multiple groups of STAs.

In step 31, an AP transmits a radio frame by broadcast to allocate a downlink transmission period and an uplink transmission period for each group of multiple groups of STAs.

Here, access parameters carried by the radio frame includes at least one of: information on a group identification of an STA and/or an identification of an STA, a starting time point of downlink transmission, a downlink transmission duration, a starting time point of uplink transmission and an uplink transmission duration.

Specifically, see FIG. 6 for the parameters included in the radio frame. The radio frame specifically includes: a message type identification, a number of groups, a group identification information list, a downlink starting offset of group 1, a downlink duration of group 1, . . . , a downlink starting offset of group n, a downlink duration of group n, an uplink starting offset of group 1, an uplink duration of group 1, . . . , an uplink starting offset of group n, an uplink duration of group n. The message type identification serves to enable a receiving end to identify a frame format of a received radio frame; the number of groups indicates on how many groups the uplink and downlink transmission period allocation is performed; a downlink starting offset, a downlink transmission duration (downlink duration), an uplink starting offset and an uplink transmission duration (uplink duration) are allocated for each group. If the AP doesn't allocate an uplink or downlink transmission period for a group of STAs, the unallocated parameter is set to 0.

A group of STAs may be STAs grouped together according to a service application, an operator, a network accessing order, or an ID number of an STA. A group identification is pre-allocated for each group, and will be included in the radio frame.

Step 32, after receiving the radio frame, an STA determines whether a downlink transmission period and an uplink transmission period are allocated in the radio frame for a group to which the STA belongs, and if so, the STA receives data in the downlink transmission period as allocated for the local group; when having data to be transmitted, the STA doesn't enter a doze state after downlink reception completes, and starts to compete for a channel upon start of uplink transmission of the group to which the STA belongs; or when having no data to be transmitted, the STA enters a doze state.

When winning a TXOP, an STA may perform transmission up to the end of the uplink transmission duration. If failing to win a TXOP, the STA enters a doze state until the uplink transmission period expires; after waiting for a fixed inter-frame interval, the STA receives a next radio frame broadcast as aforementioned; here indication of whether there will be a next broadcast radio frame may also be included in the current radio frame.

The step may also include that: after receiving the radio frame, if an STA determines that a downlink transmission period and an uplink transmission period are not allocated in the radio frame for the group to which the STA belongs, the STA may enter a doze state until the currently allocated uplink transmission period expires; after waiting for a fixed inter-frame interval, the STA receives a next radio frame broadcast as aforementioned.

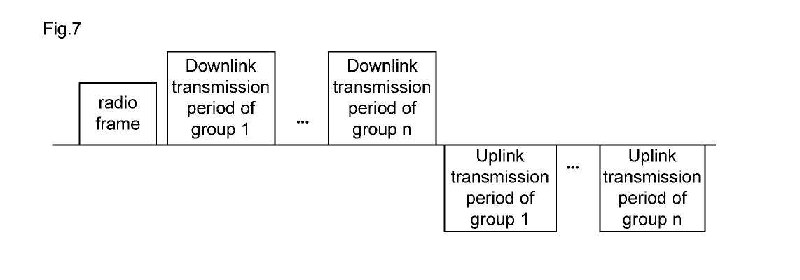

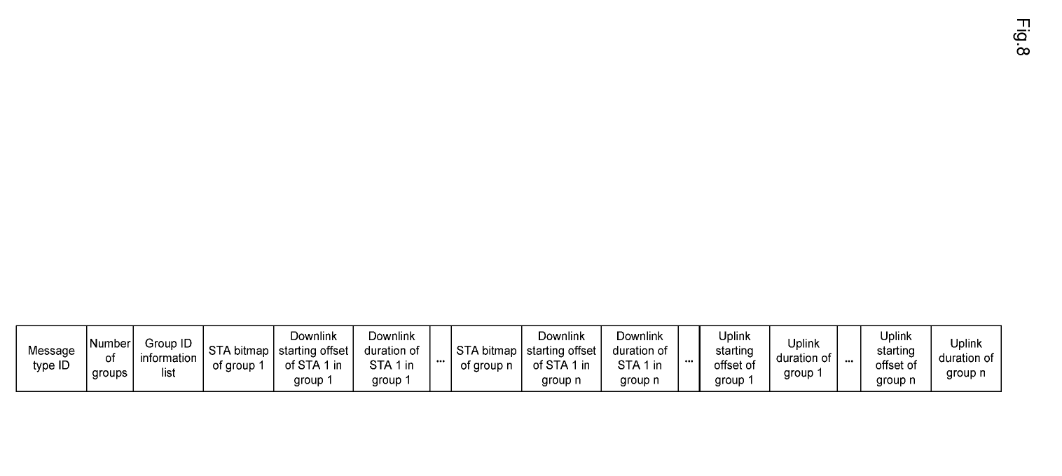

Specifically, a schematic diagram of a frame sequence of the operation process may be as shown in FIG. 7, where it can be seen that the radio frame includes access parameters of multiple groups at the same time, and each group of STAs share one downlink transmission period and one uplink transmission period; when STAs in a group need to transmit data, they compete for a channel within an uplink transmission period shared by the group to acquire a TXOP.

### Embodiment 4

In embodiment 4, a radio frame transmitted by an AP includes access parameters of multiple groups of STAs. Embodiment 4 differs from Embodiment 3 in that a downlink transmission period is allocated in the radio frame in Embodiment 4 respectively for each of one or more STAs in each group of STAs.

Step 41, an AP transmits a radio frame by broadcast to allocate downlink transmission periods and uplink transmission periods for multiple groups of STAs.

A downlink transmission period is allocated respectively for each of one or more STAs in each group of STAs. Access parameters carried by the radio frame includes at least one of: information on a group identification of an STA and/or an identification of an STA, a starting time point of downlink transmission, a downlink transmission duration, a starting time point of uplink transmission and an uplink transmission duration.

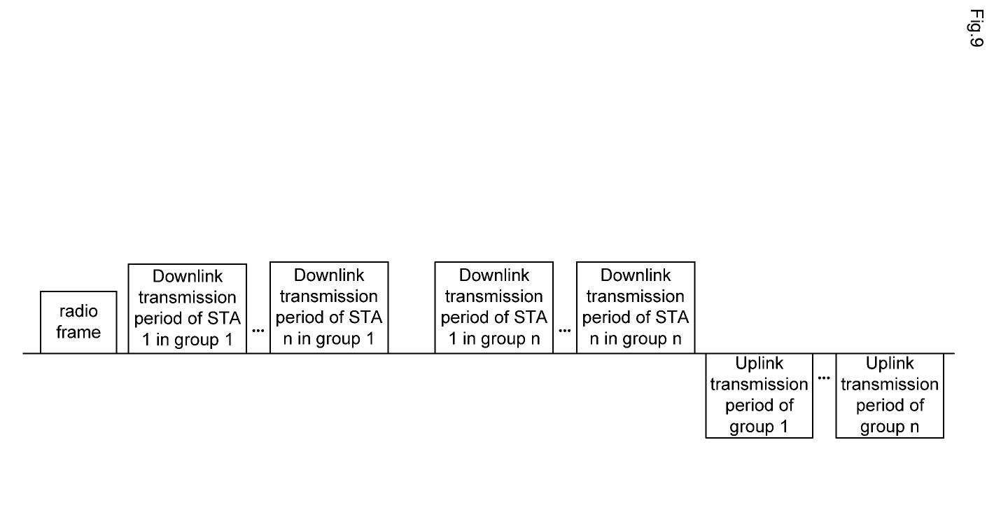

Specifically, see FIG. 8 for the parameters included in the radio frame. The radio frame specifically includes:
a message type identification, a number of groups, a group identification information list, an STA bitmap of group 1, a downlink starting offset of STA 1 in group 1, a downlink duration of STA 1 in group 1, . . . , an STA bitmap of group n, a downlink starting offset of STA 1 in group n, a downlink duration of STA 1 in group n, . . . , an uplink starting offset of group 1, an uplink duration of group 1, . . . , an uplink starting offset of group n, an uplink duration of group n. The message type identification serves to enable a receiving end to identify a frame format of a received radio frame; the number of groups indicates on how many groups the uplink and downlink transmission period allocation is performed.

In embodiment 4, as a downlink transmission period is allocated respectively for each of one or more STAs in each group, the radio frame should further include the number of STAs and a list of STA IDs or an STA bitmap. The radio frame in FIG. 8 is illustrated as including an STA bitmap; each bit in the bitmap corresponds to one STA; 1 or 0 may be used to indicate whether a downlink transmission period is allocated for an STA. An STA allocated with a downlink transmission period reads the starting time point of downlink transmission and the downlink transmission duration allocated for the STA. In addition, an uplink transmission period is allocated for each group.

Step 42, after receiving the radio frame, an STA determines whether a downlink transmission period and an uplink transmission period are allocated in the radio frame for the STA, and if so, the STA receives data in the downlink transmission period allocated for the STA; when having data to be transmitted, the STA doesn't enter a doze state after downlink reception completes, and starts to compete for a channel upon start of uplink transmission; or when having no data to be transmitted, the STA enters a doze state.

When winning a TXOP, an STA may perform transmission up to the end of the uplink transmission duration. If failing to win a TXOP, the STA enters a doze state until the uplink transmission period expires; after waiting for a fixed inter-frame interval, the STA receives a next radio frame broadcast as aforementioned.

The step may also include that: after receiving the radio frame, if an STA determines that a downlink transmission period and an uplink transmission period are not allocated in the radio frame for the STA, the STA may enter a doze state until the currently allocated uplink transmission period expires; after waiting for a fixed inter-frame interval, the STA receives a next radio frame broadcast as aforementioned.

Specifically, a schematic diagram of a frame sequence of the operation process may be as shown in FIG. 9, where it can be seen from FIG. 9 that the radio frame includes access parameters of multiple groups at the same time, and a respective downlink transmission period is allocated for each STA in each group, and STAs in each group share one uplink transmission period; when STAs in a group need to transmit data, they compete for a channel within the uplink transmission period shared by the group to acquire a TXOP.

### Embodiment 5

In Embodiment 5, an AP transmits, by broadcast, a radio frame including access parameters of one or more groups of STAs. In the embodiment, it is assumed that the radio frame includes access parameters of N groups of STAs.

Downlink and uplink transmission period allocation may be performed on each of the N groups of STAs, then access parameters of N groups of STAs included in the radio frame are: identification information of group 1 and/or identification information of STAs within group 1, and a starting time point of downlink transmission, a downlink transmission duration, a starting time point of uplink transmission and an uplink transmission duration of group 1; identification information of group 2 and/or identification information of STAs within group 2, and a starting time point of downlink transmission, a downlink transmission duration, a starting time point of uplink transmission and an uplink transmission duration of group 2; . . . , identification information of group N and/or identification information of STAs within group N, and a starting time point of downlink transmission, a downlink transmission duration, a starting time point of uplink transmission and an uplink transmission duration of group N.

In the embodiment, for one or more groups in the N groups of STAs, only a starting time point of downlink transmission and a downlink transmission duration are allocated, or only a starting time point of uplink transmission and an uplink transmission duration are allocated. For example, for group 1 and group 2 among N groups of STAs, only the downlink transmission period (a starting time point of downlink transmission and a downlink transmission duration) is allocated, and for a remaining group in the N groups, both the downlink transmission period and the uplink transmission period are allocated. Alternatively, for group 1 and group 2 among the N groups of STAs, only the uplink transmission period (a starting time point of uplink transmission and an uplink transmission duration) is allocated, and for a remaining group in the N groups, both the downlink transmission period and the uplink transmission period are allocated. Alternatively, among the N groups of STAs, for group 1 only the downlink transmission period (a starting time point of downlink transmission and a downlink transmission duration) is allocated; for group 2 only the uplink transmission period (a starting time point of uplink transmission and an uplink transmission duration) is allocated; and for a remaining group other than groups 1 and 2, both the downlink transmission period and the uplink transmission period are allocated.

Particularly, for one or more groups in the N groups of STAs, neither an uplink transmission period nor a downlink transmission duration is allocated, in which case, access parameters corresponding to the one or more groups include only information on a group identification of an STA and/or an identification of an STA.

After receiving the radio frame, an STA determines whether a downlink transmission period and an uplink transmission period are allocated in the radio frame for the STA, and if so, the STA receives data in the downlink transmission period allocated for the STA; when having data to be transmitted, the STA starts to compete for a channel upon start of uplink transmission.

After receiving the radio frame, if an STA determines that a downlink transmission period and an uplink transmission period are not allocated in the radio frame for the STA, the STA may enter a doze state until the currently allocated uplink transmission period expires; after waiting for a fixed inter-frame interval, the STA receives a next radio frame broadcast as aforementioned.

For example, the AP transmits a beacon frame or a short beacon frame including group identification information, an intra-group STA bitmap, a starting time point of uplink transmission, and an uplink transmission duration of a group. An STA in the group starts to perform uplink transmission by EDCA to transmit a PS-Poll frame or a trigger frame upon arrival of a time slot of the STA according to an order of the STA in the bitmap and a fixed or pre-negotiated slot length. Transmission durations of all the STAs in the group are no more than the uplink transmission duration of the group.

The AP may transmit a radio frame carrying parameters of an STA whose PS-Poll frame is previously received, including: information on a group identification of the STA and/or an identification of the STA (bitmap), a starting time point of downlink transmission and a downlink transmission duration. Then an STA makes sure that the STA itself is awake upon arrival of the time slot of the STA to receive downlink data transmitted by the AP according to an order in the bitmap and a fixed or pre-negotiated slot length.

The AP may transmit a radio frame carrying access parameters of one or more groups of STAs, including: information on a group identification of an STA and/or an identification of an STA, an uplink starting time point and an uplink transmission duration; after receiving the radio frame, an STA performs uplink transmission by EDCA upon arrival of uplink transmission corresponding to the STA.

In an embodiment of the disclosure, an STA accesses a channel by DCF or EDCA within a downlink transmission period and/or an uplink transmission period allocated.

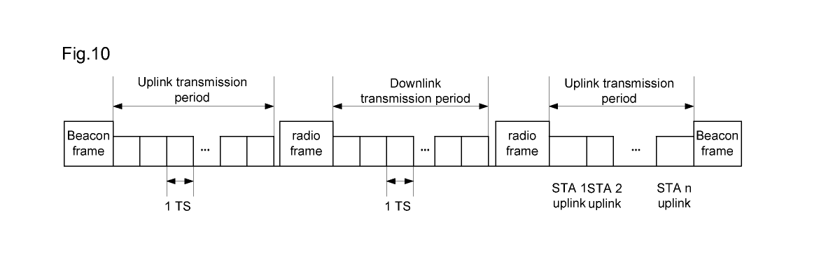

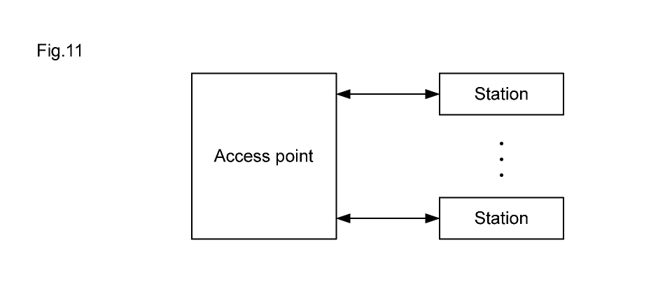

Specifically, a schematic diagram of a frame sequence may be as shown in FIG. 10.

The disclosure further provides a system for implementing the method for accessing a wireless channel; the structure of the system, as shown in FIG. 10, includes an access point and multiple STAs.

The access point is configured for transmitting a radio frame including access parameters of at least one group of STAs.

An STA of the STAs is configured for: when receiving the radio frame and determining that the STA itself belongs to the at least one group of STAs, transmitting data to be transmitted competitively within an uplink transmission period in the access parameters according to the access parameters of the group of STAs.

In an embodiment, the STA may be further configured for: when receiving the radio frame, staying in a doze state outside a downlink transmission period of the STA or of the group of STAs in the access parameters when the STA belongs to the at least one group of STAs and has no data to be transmitted; or when receiving the radio frame, staying in a doze state within the downlink transmission period and the uplink transmission period in the access parameters when the STA is not included in the at least one group of STAs.

In an embodiment, the STA may be further configured for determining whether the STA itself belongs to the at least one group of STAs according to information on a group identification of an STA and/or an identification of an STA in the access parameters.

In an embodiment, the access parameters of the at least one group of STAs include: information on a group identification of an STA and/or an identification of an STA; a starting time point of downlink transmission; and a downlink transmission duration; or
the access parameters of the at least one group of STAs include: information on a group identification of an STA and/or an identification of an STA, a starting time point of uplink transmission; and an uplink transmission duration; or
the access parameters of the at least one group of STAs include: information on a group identification of an STA and/or an identification of an STA; a starting time point of downlink transmission; a downlink transmission duration; a starting time point of uplink transmission; and an uplink transmission duration; or
the access parameters of the at least one group of STAs include: information on a group identification of an STA and/or an identification of an STA.

In an embodiment, the STA may be configured for: competing, when the STA has data to be transmitted, for a channel using a random backoff mechanism and a CSMA/CA mechanism upon arrival of a starting time point of uplink transmission in the access parameters; performing data transmission when winning the channel, wherein a period during which the STA winning the channel occupies the channel is no more than an uplink transmission duration in the access parameters; and after completing the data transmission, entering a doze state.

In an embodiment, the STA may be further configured for: when the STA has data to be transmitted and has not won the channel, after an STA winning the channel completes data transmission, continuing to compete for the channel and performing data transmission until expiration of the uplink transmission period of the group of STAs.

What described are merely embodiments of the disclosure, and are not intended to limit the scope of protection of the claims of the disclosure.

1. A method for accessing a wireless channel, comprising steps of:
transmitting, by an access point, a radio frame including access parameters of at least one group of stations; and
receiving, by a station, the radio frame, and, when the station belongs to the at least one group of stations and has data to be transmitted, transmitting the data to be transmitted competitively within an uplink transmission period in the access parameters according to the access parameters of the group of stations.

2. The method according to claim 1, further comprising:
making a station belonging to the at least one group of stations that receives the radio frame but has no data to be transmitted stay in a doze state outside a downlink transmission period of the station or of the group of stations in the access parameters; and
making a station other than the at least one group of stations that receives the radio frame stay in a doze state within the downlink transmission period and the uplink transmission period in the access parameters.

3. The method according to claim 1, further comprising: after a station receives the radio frame,
determining, by the station, whether the station itself belongs to the at least one group of stations according to information on a group identification of a station and/or an identification of a station in the access parameters.

4. The method according to claim 1, wherein
the access parameters of the at least one group of stations comprise: information on a group identification of a station and/or an identification of a station; a starting time point of downlink transmission; and a downlink transmission duration; or
the access parameters of the at least one group of stations comprise: information on a group identification of a station and/or an identification of a station, a starting time point of uplink transmission; and an uplink transmission duration; or
the access parameters of the at least one group of stations comprise: information on a group identification of a station and/or an identification of a station; a starting time point of downlink transmission; a downlink transmission duration; a starting time point of uplink transmission; and an uplink transmission duration; or
the access parameters of the at least one group of stations comprise: information on a group identification of a station and/or an identification of a station.

5. The method according to claim 1, wherein the step of transmitting the data to be transmitted competitively within an uplink transmission period in the access parameters according to the access parameters of the group of stations comprises:
competing, by the station belonging to the at least one group of stations that receives the radio frame and has the data to be transmitted, for a channel using a random backoff mechanism and a Carrier Sense Multiple Access with Collision Avoidance (CSMA/CA) mechanism upon arrival of a starting time point of uplink transmission in the access parameters; and
performing data transmission by a station winning the channel, wherein a period during which the station winning the channel occupies the channel is no more than an uplink transmission duration in the access parameters.

6. The method according to claim 5, further comprising:
after completing the data transmission, entering, by the station winning the channel, a doze state; and
continuing, by a station belonging to the at least one group of stations that has data to be transmitted, to compete for the channel and performing data transmission until expiration of the uplink transmission period of the group of stations.

7. A system for accessing a wireless channel, comprising an access point and a plurality of stations, wherein
the access point is configured for transmitting a radio frame including access parameters of at least one group of stations; and
a station of the plurality of stations is configured for: when receiving the radio frame and determining that the station itself belongs to the at least one group of stations and has data to be transmitted, transmitting the data to be transmitted competitively within an uplink transmission period in the access parameters according to the access parameters of the group of stations.

8. The system according to claim 7, wherein the station is further configured for: when receiving the radio frame, staying in a doze state outside a downlink transmission period of the station or of the group of stations in the access parameters when the station belongs to the at least one group of stations and has no data to be transmitted; or when receiving the radio frame, staying in a doze state within the downlink transmission period and the uplink transmission period in the access parameters when the station is not included in the at least one group of stations.

9. The system according to claim 7, wherein the station is further configured for determining whether the station itself belongs to the at least one group of stations according to information on a group identification of a station and/or an identification of a station in the access parameters.

10. The system according to claim 7, wherein
the access parameters of the at least one group of stations comprise: information on a group identification of a station and/or an identification of a station; a starting time point of downlink transmission; and a downlink transmission duration; or
the access parameters of the at least one group of stations comprise: information on a group identification of a station and/or an identification of a station, a starting time point of uplink transmission; and an uplink transmission duration; or
the access parameters of the at least one group of stations comprise: information on a group identification of a station and/or an identification of a station; a starting time point of downlink transmission; a downlink transmission duration; a starting time point of uplink transmission; and an uplink transmission duration; or
the access parameters of the at least one group of stations comprise: information on a group identification of a station and/or an identification of a station.

11. The system according to claim 7, wherein the station is configured for: competing, when the station has data to be transmitted, for a channel using a random backoff mechanism and a Carrier Sense Multiple Access with Collision Avoidance (CSMA/CA) mechanism upon arrival of a starting time point of uplink transmission in the access parameters; performing data transmission when winning the channel, wherein a period during which the station winning the channel occupies the channel is no more than an uplink transmission duration in the access parameters; and after completing the data transmission, entering a doze state.

12. The system according to claim 11, wherein the station is further configured for: when the station has data to be transmitted and has not won the channel, after a station winning the channel completes data transmission, continuing to compete for the channel and performing data transmission until expiration of the uplink transmission period of the group of stations.

13. The method according to claim 2, further comprising: after a station receives the radio frame,
determining, by the station, whether the station itself belongs to the at least one group of stations according to information on a group identification of a station and/or an identification of a station in the access parameters.

14. The system according to claim 8, wherein the station is further configured for determining whether the station itself belongs to the at least one group of stations according to information on a group identification of a station and/or an identification of a station in the access parameters.
